(19) United States
(12) Patent Application Publication
(10) Pub. No.: US 2008/0234421 A1
(43) Pub. Date: Sep. 25, 2008

(54) Optically-Enhanced Tire Preparation

(75) Inventors: David Lee Hart, Roswell, GA (US); Teresa J. Wolf, Marietta, GA (US); Robert Clinton Eads, Fayetteville, GA (US); Stanley Reed Weller, Marietta, GA (US); Suhail Kamal Massad, Marietta, GA (US); Clark K. Miller, Norcross, GA (US)

Correspondence Address: JOHN S. PRATT, ESQ;KILPATRICK STOCKTON, LLP, 1100 PEACHTREE STREET, ATLANTA, GA, 30309, US

(73) Assignee: Zep IP Holding LLC, Atlanta, GA (US)

(21) Appl. No.: 12/054,063

(22) Filed: Mar. 24, 2008

Related U.S. Application Data
(60) Provisional application No. 60/896,740, filed on Mar. 23, 2007.

(51) Int. Cl. C08K 3/10; C08G 77/04; C08L 83/04; C08K 3/34

(52) U.S. Cl. 524/413; 528/10; 524/449; 524/588

(57) ABSTRACT

A preparation for use on a surface of a vehicle is provided. The preparation includes a carrier containing a gloss-enhancing material and a light-reflective material for enhancing the optical properties of the gloss-enhancing material. The preparation is preferably substantially free of amino-functional silicones.

### CROSS-REFERENCE TO RELATED APPLICATION

This application claims priority to U.S. Provisional Application Ser. No. 60/896,740 filed on Mar. 23, 2007, the contents of which are incorporated by reference herein in their entirety.

### FIELD OF THE INVENTION

This application relates to a preparation for use on a substrate, such as an external surface of a vehicle. The preparation enhances the appearance and light reflective characteristics of the substrate as compared to known compositions.

### BACKGROUND OF THE INVENTION

As vehicles age, their surfaces often become dull and unattractive. Surfaces for which the aging is particularly noticeable include rubber and plastic surfaces such as tires and bumpers. Many products are available to address these undesirable aging effects. One such category of products is known as “tire dressing products.” These products are formed from various materials and have varying levels of effectiveness. One reference describes a silicone microemulsion tire dressing composition based on an amino-function silicone composition. This composition is less desirable than known tire dressing products because the amino-functional silicone is more volatile (i.e., it has a lower flash point) and the composition thus has less favorable health and handling properties than known products.

Accordingly, there is a desire for surface preparation for use on a vehicle that provides enhanced optical properties at a lower cost than previously known dressing products and that does not have the volatility, health and handling issues associated with amino-functional silicone-based compositions.

### SUMMARY OF THE INVENTION

A preparation for use on a surface of a vehicle is provided. The preparation includes a carrier containing a gloss-enhancing material and a light-reflective material for enhancing the optical properties of the gloss-enhancing material. The preparation is preferably substantially free of amino-functional silicones.

### DETAILED DESCRIPTION OF THE INVENTION

In a preferred embodiment, the preparation is a composition containing a carrier to which a light-reflective material is added. The carrier preferably includes a gloss-enhancing material that imparts some measure of optical-enhancing properties to the substrate, and the light-reflective material enhances the optical properties of the gloss-enhancing material.

Preferable carriers include water, silicone, glycerin, petroleum-based compositions, non-petroleum-based compositions, organic-based compositions, and combinations thereof. Dressing products by ZEP Inc., are particularly preferable for use as carriers.

The gloss-enhancing material in the carrier can be any material which, when applied to the substrate, improves the general gloss, shine, color, or other optical quality of the substrate. Suitable gloss-enhancing materials include, but are not limited to, silicone oil, glycerin, petroleum-based oils such as mineral oil, natural oils such as soybean and castor oil, and combinations thereof. Polydimethylsiloxane (“PDMS”) is an example of a suitable silicone oil. The gloss-enhancing material is preferably from about 10 to about 100 percent by weight of the preparation. More preferably, the gloss-enhancing material is from about 20 to about 50 percent by weight of the preparation. Even more preferably, the gloss-enhancing material is from about 25 to about 30 percent by weight of the preparation. The amount of gloss-enhancing material in the composition should be high enough to ensure that the carrier provides a general gloss to the surface onto which it is applied. Concentrations of gloss-enhancing material below about 10 percent would result in a preparation with undesirable general gloss-enhancing properties.

The light-reflective material can be any material which, when mixed with the carrier and applied to a substrate, imparts a glossy, shiny, luminescent, rainbow or sparkly appearance to the substrate. The light-reflective material may be synthetic or natural. Specific examples include mica, titanium dioxide, Mylar, craft glitter, diamond dust, cubic zirconium, other polymeric and synthetic films and materials, and combinations thereof. A preferred light-reflective material is a combination of mica and titanium dioxide.

The light reflective material is preferably a particulate material having a particle size of from about 1 μm to about 3 mm. More preferably, the light-reflective material has a particle size of from about 20 μm to about 150 μm when used in liquid or gel preparations, and has a particle size of from about 5 to about 55 μm when used in aerosol preparations.

The carrier can include additional components, such as rheology modifiers, stabilizers, preservatives, dyes, pH neutralizers, fragrances and the like. As discussed above, for cost, volatility, health and handling reasons, the preparation preferably does not include amino-functional silicones. For an aerosol preparation, a propellant such as, but not limited to, carbon dioxide is added according to methods known to those skilled in the art.

The preparation preferably contains about from about 0.001 to about 20 percent by weight light-reflective material. More preferably, the preparation contains about from about 0.1 to about 1 percent by weight light-reflective material. Preparations having from about 0.4 to about 0.5 percent by weight light-reflective material have been found to be particularly preferable.

The carrier may be in a solid, cream, gel, liquid or aerosol form. The preparation can be applied to any substrate, such as a surface of a vehicle, where it is desirable to provide a glossy, shiny, luminescent, rainbow or sparkly appearance to the substrate. The preparation can be used on any type of personal or commercial vehicle, including, but not limited to, automobiles, trucks, motorcycles, mopeds, scooters, bicycles, recreational vehicles, boats and the like. Particular components where the preparation may be desirable include, but are limited to, tires, vinyl, dashboards, rubber, trim, and bumpers. The preparation is particularly well-suited for use on rubber or plastic surfaces of vehicles. The preparation described herein, when applied to these or other substrates, provides a substantial visual improvement in the “look” of the substrate as compared to known compositions. It has even been observed that certain preparations, such as those containing craft glitter, will impart a rainbow or prism-like effect to the substrate when the craft glitter is added to the carrier in an amount approaching the upper ranges of the preferred composition described above.

The compositions described above will be further understood with reference to the following non-limiting examples.

### EXAMPLE 1

A viscous, gel-like preparation was formed from the following components:

| Component: | Approximate percent by weight: |
|---|---|
| Aliphatic solvent | 11 |
| Silicone agent (PDMS) | 30 |
| Mica/titanium dioxide | 0.5 |
| (particle size 20-150 μm) | |
| Water | 57 |
| Thickener, preservative, surfactant/ | Balance |
| wetting agent, neutralizer | |

The aliphatic solvent, silicone agent and thickener were combined and agitated until dispersed. The mica/titanium dioxide mixture was then added slowly and agitated until evenly dispersed. The water, preservative, surfactant/wetting agent and neutralizer were slowly added and mixed with good agitation. The neutralizer was added so as to bring the pH of the preparation to about 7.0 to 9.0. Air was introduced into the bottom of the preparation as needed for better mixing.

The resulting preparation was opaque and had a white color with a slight shimmer. When applied to an automotive tire, the preparation provides a noticeable improvement in the visual appearance of the tire as compared to a similar preparation that does not include the mica/titanium dioxide mixture.

### EXAMPLE 2

An aerosol preparation was formed from the following components:

| Component: | Approximate percent by weight: |
|---|---|
| Aliphatic solvent | 5 |
| Hydrocarbon-based solvent | 5 |
| Acetate-based solvent | 58 |
| Silicone agent (PDMS) | 25 |
| Mica/titanium dioxide | 0.4 |
| (particle size 5-55 μm) | |
| Carbon dioxide | Balance |

The aliphatic solvent, hydrocarbon-based solvent and acetate-based solvent were combined and mixed. The silicone agent was then added and mixed. The mica/titanium dioxide mixture was then added slowly and agitated until evenly dispersed. Continuous mixing was used to ensure that the mica/titanium dioxide did not settle in the mixture. The preparation was compounded and packaged in aerosol containers relatively quickly (i.e., within about a day) according to methods known by one skilled in the art.

When applied to an automotive tire, the resulting preparation provides a noticeable improvement in the visual appearance of the tire as compared to a similar preparation that does not include the mica/titanium dioxide mixture.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. A preparation for use on a surface of a vehicle, comprising:
a carrier comprising a gloss-enhancing material; and
a light-reflective material for enhancing the optical properties of the gloss-enhancing material,
wherein the preparation is substantially free of amino-functional silicones.

2. The preparation of claim 1, wherein the carrier further comprises a solvent.

3. The preparation of claim 2, wherein the solvent is water, silicone, glycerin, petroleum, non-petroleum, or organic-based.

4. The preparation of claim 1, wherein the gloss-enhancing material comprises silicone oil, glycerin, petroleum oil, or natural oil.

5. The preparation of claim 4, wherein the gloss-enhancing material is polydimethylsiloxane.

6. The preparation of claim 1, wherein the gloss-enhancing material is from about 10 to about 100 percent by weight of the preparation.

7. The preparation of claim 1, wherein the gloss-enhancing material is from about 25 to about 30 percent by weight of the preparation.

8. The preparation of claim 1, wherein the light-reflective material is a polymeric or synthetic material.

9. The preparation of claim 1, wherein the light-reflective material is selected from the group consisting of mica, titanium dioxide, Mylar, craft glitter, diamond dust, cubic zirconium and combinations thereof.

10. The preparation of claim 9, wherein the light-reflective material comprises mica and titanium dioxide.

11. The preparation of claim 1, wherein the light-reflective material has a particle size of from about 1 μm to about 3 mm.

12. The preparation of claim 1, wherein the light-reflective material has a particle size of from about 20 μm to about 150 μm.

13. The preparation of claim 1, wherein the light-reflective material has a particle size of from about 5 μm to about 55 μm.

14. The preparation of claim 1, wherein the light-reflective material is from about 0.001 to about 20 percent by weight of the preparation.

15. The preparation of claim 1, wherein the light-reflective material is from about 0.1 to about 1 percent by weight of the preparation.

16. The preparation of claim 1, wherein the preparation is in liquid, solid, cream, gel or aerosol form.

17. The preparation of claim 1, wherein the gloss-enhancing material is polydimethylsiloxane and is from about 25 to about 30 percent by weight of the preparation.

18. The preparation of claim 1, wherein the gloss-enhancing material is polydimethylsiloxane and is from about 25 to about 30 percent by weight of the preparation and the light-reflective material comprises mica and titanium dioxide and is from about 0.1 to about 1 percent by weight of the preparation.

19. The preparation of claim 1, wherein the gloss-enhancing material is polydimethylsiloxane and is from about 25 to about 30 percent by weight of the preparation, the light-reflective material comprises mica and titanium dioxide and is from about 0.1 to about 1 percent by weight of the preparation, and the light reflective material has a particle size of from about 5 μm to about 55 μm.

20. The preparation of claim 1, wherein the gloss-enhancing material is polydimethylsiloxane and is from about 25 to about 30 percent by weight of the preparation, the light-reflective material comprises mica and titanium dioxide and is from about 0.1 to about 1 percent by weight of the preparation, and the light reflective material has a particle size of from about 20 μm to about 150 μm.
